(19) United States
(12) Patent Application Publication
(10) Pub. No.: US 2017/0027808 A1
(43) Pub. Date: Feb. 2, 2017

(54) Exercise Roller

(71) Applicant: Angelo Castiglione, Sydney (AU)

(72) Inventor: Angelo Castiglione, Sydney (AU)

(21) Appl. No.: 14/999,428

(22) Filed: Apr. 22, 2015

Related U.S. Application Data
(63) Continuation of application No. 13/201,360, filed on Aug. 16, 2011, now abandoned.

(51) Int. Cl. A61H 15/00

(52) U.S. Cl. CPC A61H 15/0092; A61H 2015/0014; A61H 2201/0134; A61H 2201/1284

(57) ABSTRACT

An exercise roller is comprised of at least two sub exercise roller units, the sub exercise roller units connected together to form a single exercise roller and separable to be usable as separate exercise rollers.

### FIELD OF INVENTION

This invention relates to exercise rollers and improvements to make a more versatile exercise roller.

### BACKGROUND

Foam rollers are used in the exercise and therapy industries for strength and conditioning as well as self massage and flexibility training. These foam rollers come as a single unitary piece, traditionally either 300 mm or 900 mm long.

For some uses a 900 mm long roller is desired whilst for other uses a 300 mm long roller is desired. Generally a short roller cannot be used where a long roller is desired and vice versa. Thus it is necessary to have two or more rollers of different lengths. In a similar manner there are situations where one may desire to have rollers of different diameters. Again this has required the use of separate rollers of different diameters.

### SUMMARY OF THE INVENTION

In an attempt to overcome at least one of the aforementioned problems the invention provides a roller comprised of two or more sub units.

In another form the invention provides an exercise roller comprised of at least two sub exercise roller units, the sub exercise roller units connected together to form a single exercise roller and separable so that at least one sub exercise roller unit is usable as a separate exercise roller.

The sub units may be generally tubular, cylindrical or rod like foam rollers that engage end on end. The sub units may be other shapes or may be rigid.

The roller may comprise a first tubular or cylindrical sub unit having an internal longitudinally extending passageway with a second sub unit engaging, preferably snugly, within the passageway. The passageway may extend only partially along the length or may extend fully along the length, being open at both ends.

Each sub unit may itself be formed or two or more parts. One or more sub units may comprise a first tubular or cylindrical part having an internal longitudinally extending passageway with a second part engaging, preferably snugly, within the passageway. The second part may be a solid rod like part or may be a tubular or cylindrical part. Where the second part is tubular or cylindrical a third (solid) part may be located within the second part.

Thus the roller according to invention may comprise two, three or more separate sub units or components.

Where a tubular part is provided, whether or not it has a component within itself, the tubular part may be formed of a relatively rigid material, such as PVC, or may be formed of a foamed material.

If desired a roller may be provided with an outer rigid tube, an inner tubular foamed core and a central solid foamed core. The rigid outer tube may be the full length of the roller or may be formed or two or more lengths joined together. The number of parts of each sub unit need not be equal. Thus the outer tube may be a single unit whilst the inner tube and/or central core may be formed of two or more lengths.

Where a sub unit is formed of end on end lengths the lengths may be of equal or unequal lengths.

Providing a roller in two or more parts allows individuals that travel the ability to take all or part of the roller with them anywhere. The user has the choice, depending on the configuration of the roller, of taking the whole unit, a shorter length but full diameter roller or a smaller diameter roller, both long and short versions. In addition, if the roller is comprised of two end on end sub units both may be taken and joined together when needed, making a more easily transported roller. Having separate parts can be a discerning factor of whether an athlete or individual brings the roller along with them as the standard roller doesn't allow this, hence maximising the use of the tool and it's benefits.

In the preferred form of the invention the roller is comprised of two sub units and each sub unit is comprised of a first tubular or cylindrical part with a longitudinally extending internal passageway with a second part snugly engaging within the passageway.

The internal bore of the first part and the corresponding second part are preferably circular in cross section.

Where the sub units are attached to each other end on end means for attachment are provided on one or both ends on the sub units. In the preferred form of the invention this is comprised of hook and loop fastener material, such as that sold under the Trade Mark of Velcro. Other means for attachment may be used. As examples, complementary press stud type fasteners or tongue and groove type fasteners may be used. A tongue and groove arrangement that engages by rotation about the roller axis, such as found on containers for bulk CD's, may be used. A tongue and groove arrangement that engages by sideways movement of the sub units relative to each other may be used.

Unless the context clearly requires otherwise, throughout the description and the claims the words ‘comprise’, ‘comprising’, and the like are to be construed in an inclusive sense as opposed to an exclusive or exhaustive sense; that is to say, in the sense of “including, but not limited to”.

### BRIEF DESCRIPTION OF THE DRAWINGS

FIG. 1 shows an outline perspective view of a first example of the invention;

FIG. 2 shows a detail view of the end of part of the first example of FIG. 1;

FIG. 3 shows an outline perspective view of a second example of the invention;

FIG. 4 shows a detail view of the end of part of the second example of FIG. 3;

FIG. 5 shows a side cross section of a variation of the second example;

FIG. 6 shows a detail view of the end of a variation of the first example, and

FIG. 7 shows a detail view of the end of a variation of the second example.

### DETAILED DESCRIPTION OF PREFERRED AND OTHER EMBODIMENTS

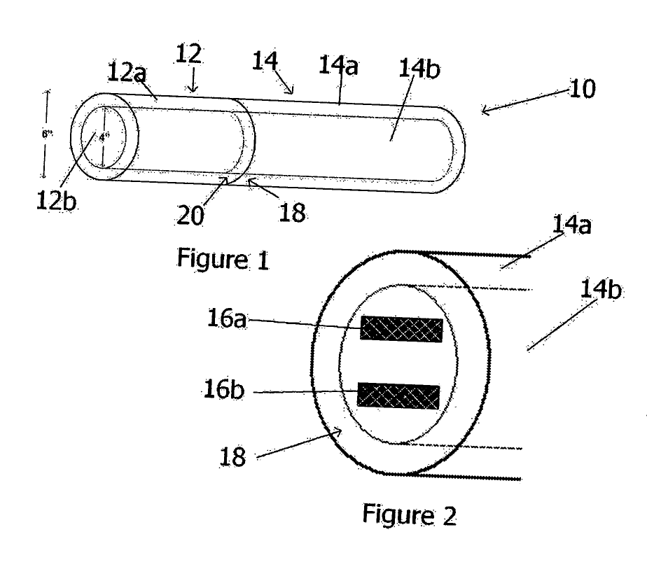

Referring to FIGS. 1 and 2 there is shown a roller 10 according to an example of the invention. The roller 10 is comprised of two sub units 12 and 14. The sub unit 12 is about 560 mm long whilst the sub unit 14 is about 360 mm long.

The two sub units 12 and 14 are joined end on end using attachment means, which in this example is hook and loop fastener material 16 a, 16 b, shown in FIG. 2 on the end 18 of sub unit 14. It will be appreciated that there will be complementary strips on the opposed end 20 of sub unit 12. The strips 16 a, 16 b may both be hook or loop material or one may be hook material and the other loop material.

The two sub units, when joined thus form a single roller about 900 mm long. The two sub units may be separated, so providing two separate rollers of shorter length. Thus a single 900 mm long roller may provide the functionality of both a long roller and a short roller. The two sub units 12, 14 need not be of unequal length and may be of equal lengths.

Each sub unit is comprised of a hollow tubular or cylindrical outer shell 12 a, 14 a and a solid rod like inner part 12 b, 14 b. The inner and outer parts of a sub unit are preferably the same length. The outer shells 12 a, 14 a have an outside diameter of about 6 inches (^{˜}150 mm) and the inner bore 22 a, 24 a of each is about 4 inches (^{˜}100 mm) in diameter. The solid inner parts 12 b and 14 b have a diameter similar to that of the inner bores 22 a, 24 a and are dimensioned so that they are a snug fit but may be readily removed from the corresponding outer part 12 a, 14 a. The ends of the sub units may be provided with means to secure the inner and outer components together and prevent or resist the inner parts accidentally sliding out of the outer parts.

Thus when a large diameter roll is required (whether it is short or long) the roller is used with the inner part(s) inserted within the outer part(s).

When a small diameter roller is required one or both of the inner parts is removed from the corresponding outer part and used either alone or attached together. As seen in FIG. 2 at least part of the attachment means 16 is attached on the inner part and so the two inner parts may be attached together.

It will be appreciated that the inner parts 12 a and 12 b together may be considered sub units of part 12 and similarly parts 14 a and 14 b together may be considered sub units of part 14.

Whilst the inner parts 12 b and 14 b extend the full length of the respective parts 12 a and 14 a they need not. The bores 22 a, 24 a may be closed at one end or may extend the full length with the inner parts 12 b and 14 b being shorter.

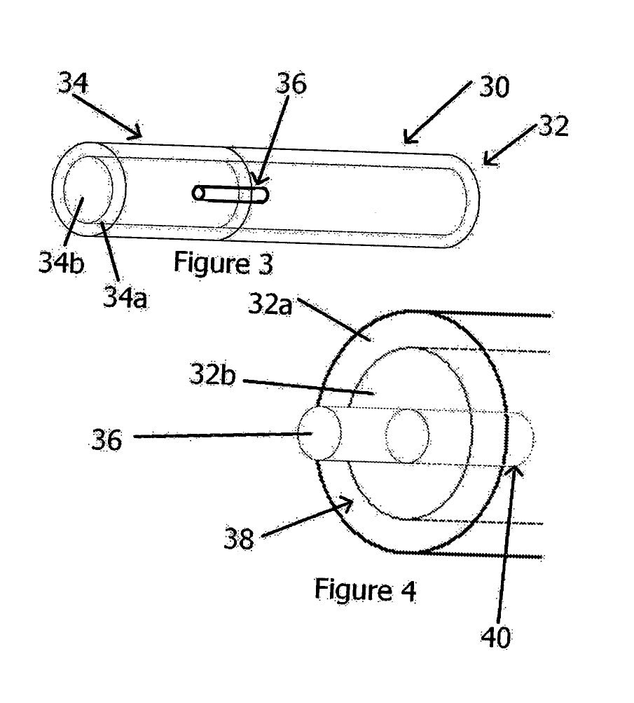

Referring to FIGS. 3 and 4, there is shown a roller 30 according to another example of the invention. The roller 30 is comprised of two sub units 32 and 34. The sub unit 32 is about 560 mm long whilst the sub unit 34 is about 360 mm long. Again sub unit 32 and 34 may be of equal lengths.

The two sub units 32 and 34 are joined end on end using attachment means, which in this example is rod 36, shown in FIG. 4 on the end 38 of sub unit 34. The rod 36 is preferably of wood but may be formed of other materials. The rod 36 is about 27 mm in diameter and about 210 mm long. The rod may be shorter or longer and, particularly for large users, may be 270 mm long. The rod is received in a bore 40 about half the length of the rod. The other part 34 has a similar bore in its opposing face. The rod 36 is a preferably a snug fit in the bore 40 so that when inserted and the two parts 32, 34 are joined together they are relatively rigidly joined.

The rod is preferably sized so that it may be used as a foot roller and the dimensions mentioned above are chosen for this purpose. The dimensions of the rod 36 may be different, particularly if it is not intended that the rod 36 be used as a separate item of exercise equipment.

The example of FIGS. 3 and 4 is similar to that of FIGS. 1 and 2 and each sub unit is comprised of a hollow tubular or cylindrical outer shell 32 a, 34 a and a solid rod like inner part 32 b, 34 b. The inner and outer parts of a sub unit are preferably the same length. The outer shells 32 a, 34 a have an outside diameter of about 6 inches (^{˜}150 mm) and the inner bore 22 a, 24 a of each is about 4 inches (^{˜}100 mm) in diameter. The solid inner parts 32 b and 34 b have a diameter similar to that of the inner bores 22 a, 24 a and are dimensioned so that they are a snug fit but may be readily removed from the corresponding outer part 32 a, 34 a. The ends of the sub units may be provided with means to secure the inner and outer components together and prevent or resist the inner parts accidentally sliding out of the outer parts.

Whilst a simple bore in the inner portions 32 a and 34 a is preferred, the rod 36 may be received in a locking type bore to more securely retain the rod 36 in the respective bore.

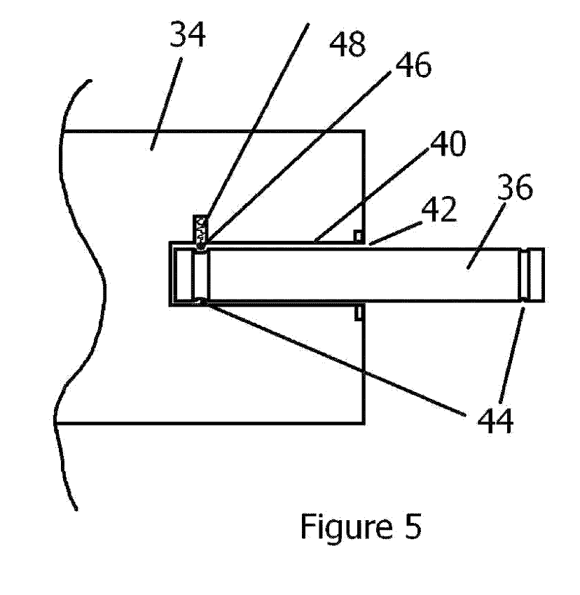

FIG. 5 shows a variation in which an insert 40 is located in the end of each sub unit 32, 34. The insert 40 has a bore 42 sized to received the rod 36. The rod 36 has a circumferential groove 44 at each end and each insert has one or more spring loaded balls 46 that are urged to partially enter the bore 42 by spring 48. When the rod 36 is inserted into the bore 42 the ball 46 is deflected and then biased against the groove, thereby retaining the rod 36 in the bore 42.

A roller may be assembled of more than two sub units.

Whilst the two sub units of the example shown are each comprised of two parts, it is not essential that this be so. Two solid sub units may be used. Where two sub units are used one may be solid and the other may be a two piece unit. Where two or more two piece sub units are used, the diameters of the inner bore and corresponding inner part need not be the same. For example, one inner part may be 4 inches in diameter and the other part 3 inches in diameter. Whilst a two piece sub unit is shown, if desired a sub unit may be formed of three or more generally concentric components.

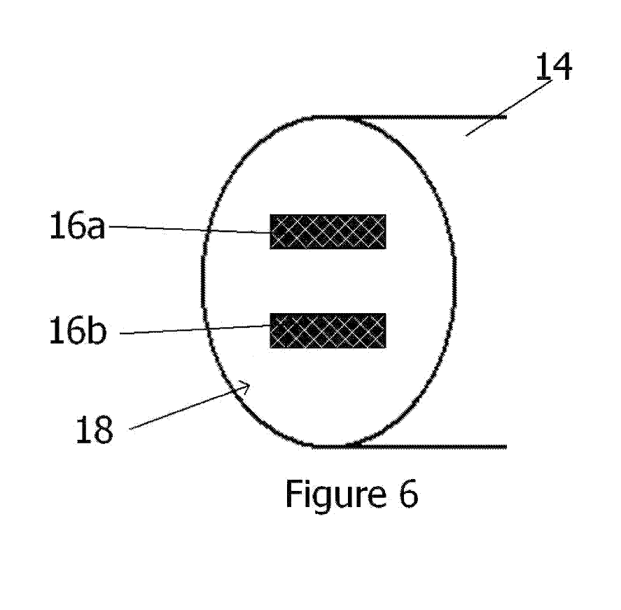

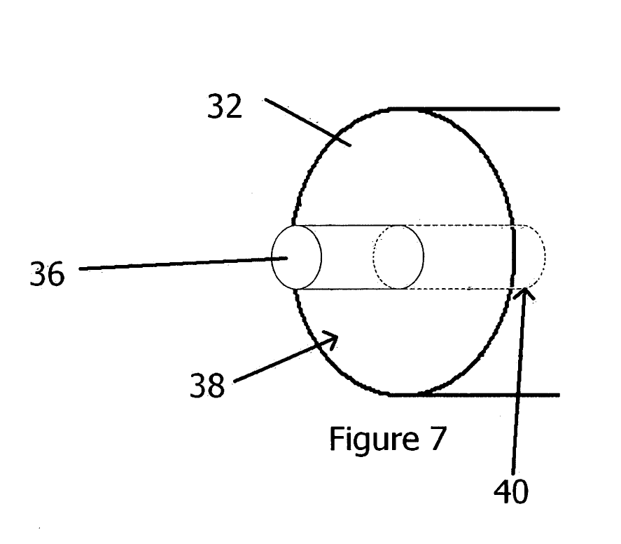

FIGS. 6 and 7 show variations of the first two examples, in which at least one sub unit 12 a, 32 a respectively is formed of a single piece of foam. The foam may be of any suitable diameter such as 4 or 6 inches in diameter.

Whilst the examples shown have a solid roller, this is not essential—it is merely necessary that the roller has the desired amount of resilience. Depending on the material used the roller may be solid or may have one or more longitudinally extending passageways. These passageways may extend through a unitary sub unit, or one or more components of a multi piece sub unit

Whilst hook and loop fastener is preferred other appropriate detachable and re-attachable fasteners may be used.

It will be apparent to those skilled in the art that many obvious modifications and variations may be made to the embodiments described herein without departing from the spirit or scope of the invention.

1. An exercise roller comprised of at least two sub exercise roller units, the sub exercise roller units connected together to form a single exercise roller and separable so that at least one sub exercise roller unit is usable as a separate exercise roller.

2. The exercise roller of claim 1 wherein adjacent sub exercise roller units engage end on end.

3. The exercise roller of claim 1 wherein at least one sub exercise roller units is tubular, cylindrical or rod like.

4. The exercise roller of claim 1 wherein at least one sub exercise roller unit is a substantially unitary.

5. The exercise roller of claim 1 wherein at least one sub exercise roller unit comprises a first tubular or cylindrical part having an internal longitudinally extending passageway with a second part snugly engaging within the passageway.

6. The exercise roller of claim 5 wherein the second part is rod like, tubular or cylindrical.

7. The exercise roller of claim 5 wherein the second part is a second sub exercise roller unit snugly engaged within the passageway.

8. The exercise roller of claim 5 wherein the second part is tubular or cylindrical and a third part is located within the second part.

9. The exercise roller of claim 5 wherein the passageway extends the length of the first sub exercise roller unit.

10. The exercise roller of claim 1 wherein at least two sub units are attached to each other end on end and means for attachment are provided on one or both adjacent ends on the sub units.

11. The exercise roller of claim 10 wherein the means for attachment is comprised of hook and loop fastener material.

12. The exercise roller of claim 10 wherein the means for attachment includes a bore in each of the adjacent ends of the two sub units and a joiner received within said bores.

13. The exercise roller of claim 12 wherein the joiner is a sub exercise roller unit.

14. The exercise roller of claim 1 wherein at least one sub exercise roller units is formed of a foamed material.

15. (canceled)
